(19) United States
(12) Patent Application Publication
(10) Pub. No.: US 2010/0130262 A1
(43) Pub. Date: May 27, 2010

(54) WIRELESS USER INTERFACE APPARATUS FOR USE WITH PERSONAL COMMUNICATIONS DEVICES

(76) Inventors: Eugene A. Fusz, Palm Beach, FL (US); William Ross Fusz, Palm Beach, FL (US)

Correspondence Address: Patent Docket Department;Armstrong Teasdale LLP, One Metropolitan Square, Suite 2600, St. Louis, MO, 63102-2740, US

(21) Appl. No.: 12/275,430

(22) Filed: Nov. 21, 2008

(51) Int. Cl. H04M 1/00

(52) U.S. Cl. 455/569.1

(57) ABSTRACT

Apparatus for interfacing with a personal communication device having at least one device transceiver. The apparatus includes a first portion having a first wireless transceiver configured to communicate with the device transceiver using a first wireless connection to facilitate transmitting incoming communication data from the communication device to a user through the first portion. The apparatus also includes a second portion having a second wireless transceiver configured to communicate with the device transceiver using a second wireless connection maintained simultaneously to the first wireless connection to facilitate transmitting outgoing communication data from the user to the communication device through the second portion.

### BACKGROUND OF THE INVENTION

The subject matter disclosed herein relates generally to accessories for use with personal communications devices and, more particularly, to a earpiece and mouthpiece that wirelessly communicate with a personal communications device, such as a phone.

At least some known personal communications devices, such as cellular phones, are configured to communicate with accessory devices that include an earpiece and a microphone to facilitate hands free use of such communications devices. For example, at least such known accessory devices are designed as a traditional headset that includes a boom microphone. Such a headset may include a single earpiece sized to fit over a user's ear, or may include two earpieces to cover both ears. The microphone extends outward from the headset and extends towards the user's mouth. The headset may be worn over the user's head or may extend only partially across the user's head.

Moreover, such accessory devices may be designed as a more compact solution including a single earpiece and a boom microphone that extends only partially towards the user's mouth. The earpiece may be sized to be partially inserted into the user's ear canal while extending outward from the ear to enable the microphone to extend towards the user's mouth. Alternatively, the earpiece may include a portion that wraps around the top of the user's ear to secure the earpiece and microphone.

However, such accessory devices are conspicuous, may be cumbersome to insert and remove, and may be uncomfortable to wear for an extended period of time. As such, an apparatus is desirable that may be worn comfortably for an extended period and is discrete and inconspicuous during use. Moreover, an apparatus is desirable that communicates wirelessly with the user's cellular phone or other personal communications device, without any physical connection.

### BRIEF DESCRIPTION OF THE INVENTION

In one aspect, an apparatus is provided for interfacing with a personal communication device having at least one device transceiver. The apparatus includes a first portion having a first wireless transceiver that is configured to communicate with the device transceiver using a first wireless connection to facilitate transmitting incoming communication data from the communication device to a user through the first portion. The apparatus also includes a second portion having a second wireless transceiver that is configured to communicate with the device transceiver using a second wireless connection maintained simultaneously to the first wireless connection to facilitate transmitting outgoing communication data from the user to the communication device through the second portion.

In another aspect, a method of interfacing with a personal communication device having at least one device transceiver using an interface device is provided. The method includes receiving, by a first wireless transceiver, incoming communication data from the device transceiver via a first wireless connection, wherein the first wireless transceiver is part of a first portion of the interface device, and processing the incoming communication data to form an incoming audio signal to be audibly output to a user by the first portion. The method also includes detecting an outgoing audio signal using a second portion of the interface device, processing the outgoing audio signal to form outgoing communication data, and transmitting, by a second wireless transceiver within the second portion, the outgoing communication data to the device transceiver using a second wireless connection.

In another aspect, a personal communication system is provided, including a communication device having a transceiver that is configured to communicate using multiple simultaneous wireless connections, and an interface apparatus. The interface apparatus includes a first portion and a separate second portion, and is configured to receive input communication data via a first wireless connection from the communication device using a first wireless transceiver within the first portion and to transmit output communication data to the communication device via a second wireless connection using a second wireless transceiver within the second portion.

### BRIEF DESCRIPTION OF THE DRAWINGS

The embodiments described herein may be better understood by referring to the following description in conjunction with the accompanying drawings.

FIG. 1 is a block diagram of an exemplary apparatus for interfacing with a personal communication device.

FIG. 2 is a block diagram of another exemplary apparatus for interfacing with a personal communication device.

FIG. 3 is a block diagram of an exemplary personal communication system that includes the interface apparatus shown in FIG. 1.

FIG. 4 is a block diagram of a second exemplary personal communication system that includes the interface apparatus shown in FIG. 2.

FIG. 5 is a flowchart that illustrates an exemplary method of interfacing with the personal communication device shown in FIGS. 3 and 4 using the interface device shown in FIGS. 1 and 2.

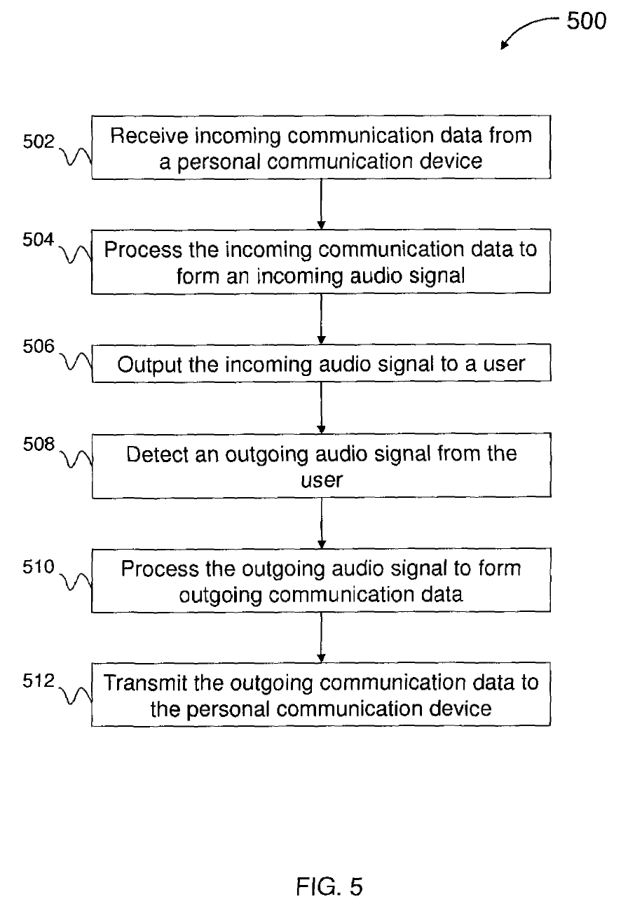

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a,” “an” and “the” arc not intended to refer to only a singular entity, but include the general class of which a specific example may be used for illustration. The terminology herein is used to describe specific embodiments of the invention, but their usage does not delimit the invention, except as outlined in the claims.

As used herein, the terms “wireless communication” and “wirelessly communicate” generally refers to a transmission of communication signals, such as voice signals and/or data signals, between devices. For example, as described herein, a first portion of a user interface device, such as an earpiece, may wirelessly communicate with a personal communication device, such as a cellular phone. In addition, as used herein, the term “wireless communication protocol” refers generally to a communications protocol that facilitates transmitting and receiving communications signals over a wireless connection. Examples of wireless communication protocols include Bluetooth®, Wi-fi, and ZigBee® (Bluetooth® is a registered trademark of Bluetooth SIG, Inc., Bellevue, Wash., USA, and ZigBee® is a registered trademark of ZigBee Alliance Corporation, San Ramon, Calif., USA). However, various embodiments of the invention may utilize alternative protocols.

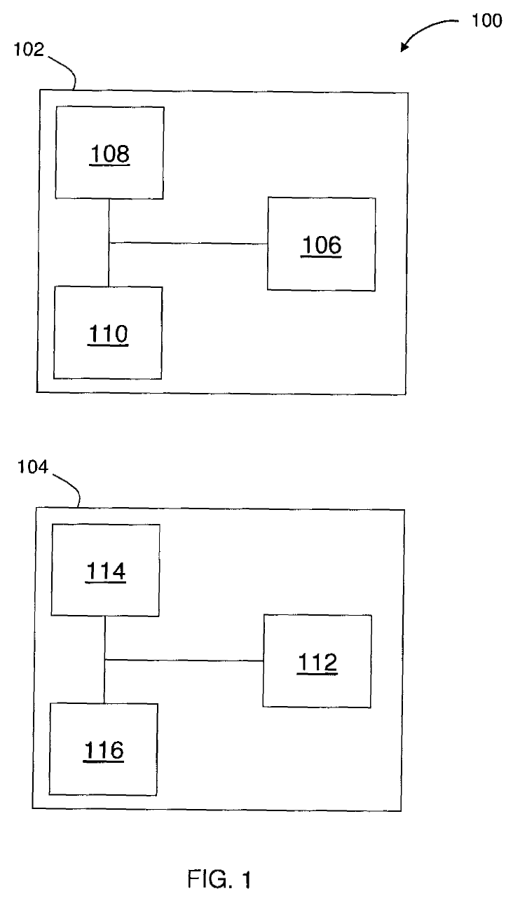

FIG. 1 is a block diagram of an exemplary apparatus 100 for interfacing with a personal communication device (not shown in FIG. 1), such as a cellular phone, that includes a wireless transceiver capable of forming multiple simultaneous wireless connections. In the exemplary embodiment, apparatus 100 includes a first portion 102 and a separate second portion 104. First portion 102 includes a wireless transceiver 106, a processor 108, and a speaker 110. More specifically, processor 108 is operatively coupled to wireless transceiver 106 and speaker 110. Moreover, second portion 104 includes a wireless transceiver 112, a processor 114, and a microphone 116. More specifically, processor 114 is operatively coupled to wireless transceiver 112 and microphone 116. In the exemplary embodiment, wireless transceivers 106 and 112 are configured to transmit and/or receive incoming communication data using a Bluetooth(t communication protocol. However, alternative embodiments may be configured to transmit and/or receive incoming communication data using different protocols, such as ZigBee®.

In one embodiment, first wireless transceiver 106 is configured to communicate wirelessly with second wireless transceiver 112 rather than with the personal communication device. In such an embodiment, second wireless transceiver 112 is configured to communicate wirelessly with the personal communication device and with first wireless transceiver 106. In an alternative embodiment, first wireless transceiver 106 is configured to communicate wirelessly with the personal communication device and with second wireless transceiver 112, and second wireless transceiver 112 is configured to communicate wirelessly only with first wireless transceiver 106.

In one embodiment, first portion 102 is sized to be inserted into the user's ear canal. Moreover, in one embodiment, second portion 104 may be applied to the user's throat using a strap and/or an adhesive (neither shown). In an alternative embodiment, second portion 104 may be applied to an article of the user's clothing, such as a shirt collar, using an adhesive and/or a pin. In another alternative embodiment, second portion 104 may be applied to the user's jaw bone. In such an embodiment, microphone 116 is a vibration microphone that, when applied to a bone, such as a jaw bone, detects sounds based on vibrations that are caused by speech.

During use, the personal communication device transmits communication data using a communication protocol to first portion wireless transceiver 106 using a first wireless connection. Wireless transceiver 106 receives the communication data and transmits the communication data to first portion processor 108. Based on the communication data, processor 108 generates an audio signal and transmits the audio signal to speaker 110. The audio signal is then output by speaker 110 to the user. To facilitate increasing the user's comfort, first portion 102 is sized to be inserted into the user's ear canal.

When the user responds to the audio signal output by speaker 110, a user-generated audio signal is detected by microphone 116. Microphone 116 transmits the audio signal to second portion processor 114. Based on the audio signal, processor 114 generates user-generated communication data and transmits the communication data to second portion wireless transceiver 112. Wireless transceiver 112 then transmits the communication data to the personal communication device using a second wireless connection.

Alternatively, the personal communication device transmits communication data using a communication protocol to second wireless transceiver 112, which then transmits the communication data to first wireless transceiver 106. First processor 108 generates an audio signal for output to the user via speaker 110, as described above. When the user responds to the audio signal output by speaker 110, microphone 116 detects the audio signal and second processor 114 generates related communication data as described above. Second wireless transceiver 112 then transmits the communication data to the personal communication device. In an alternative embodiment, the personal communication device transmits communication data to first wireless transceiver 106, and the communication data is processed and output to the user as described above. When the user responds, outgoing communication data is detected and processed as described above. The outgoing communication data is then transmitted by second wireless transceiver 112 to first wireless transceiver 106, and then by first wireless transceiver 106 to the personal communication device.

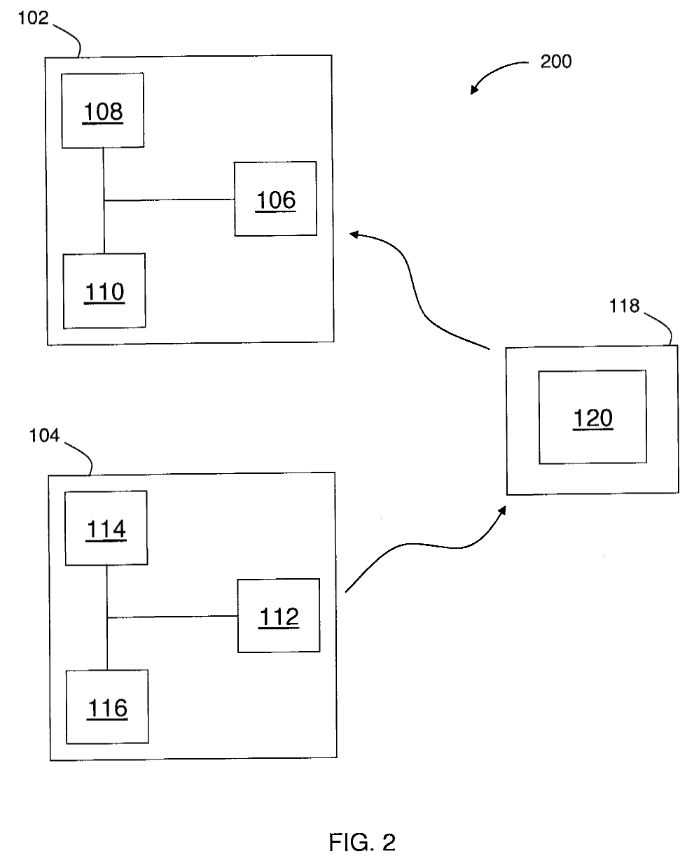

FIG. 2 is a block diagram of an exemplary apparatus 200 for interfacing with a personal communication device (not shown in FIG. 2), such as a cellular phone, that is not capable of forming multiple simultaneous wireless connections. In the exemplary embodiment, apparatus 200 includes first portion 102 and second portion 104 as described above. Moreover, apparatus 200 includes a third portion 118 that is communicatively coupled to the personal communication device. Third portion 118 may be coupled, such as removeably coupled, to the personal communication device. For example, third portion 118 may include a clasp that physically couples third portion 118 to the personal communication device in such a way that third portion 118 may be coupled to the device and/or de-coupled from the device by the user. Moreover, third portion 118 includes a wireless transceiver 120 that receives communication data from the device and transmits the communication data to first portion 102. Third portion wireless transceiver 120 also receives communication data from second portion 104 and transmits the communication data to the personal communication device. Third portion 118 may be used when, for example, the personal communication device is unable to form more than one wireless connection that uses the chosen wireless communication protocol. Moreover, third portion wireless transceiver 120 may be communicatively coupled to the personal communication device using a wired connection or using a wireless communication protocol.

During use, the personal communication device transmits communication data using a communication protocol to third portion wireless transceiver 120. The personal communication device may transmit the communication data via a wired connection or via a first wireless connection. Third portion wireless transceiver 120 then transmits the communication data to first portion wireless transceiver 106 via a second wireless connection. As described above, wireless transceiver 106 receives the communication data and transmits the communication data to first portion processor 108. Based on the communication data, processor 108 generates an audio signal and transmits the audio signal to speaker 110. The audio signal is then output by speaker 110 to the user.

When the user responds to the audio signal output by speaker 110, a user-generated audio signal is detected by microphone 116. Microphone 116 transmits the audio signal to second portion processor 114. Based on the audio signal, processor 114 generates user-generated communication data and transmits the communication data to second portion wireless transceiver 112. Wireless transceiver 112 then transmits the communication data to third portion wireless transceiver 120 using a third wireless connection. Third portion wireless transceiver 120 then transmits the communication data to the personal communication device via the first wireless connection or via a wired connection.

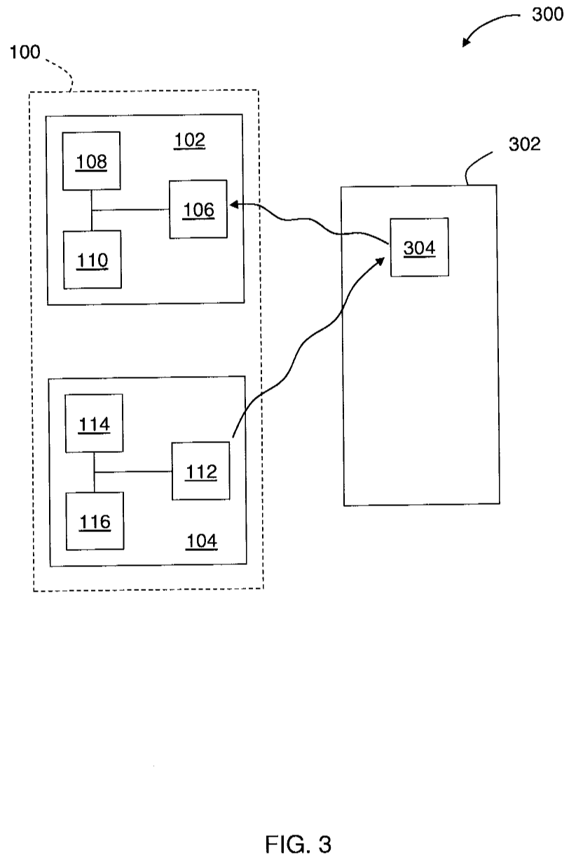

FIG. 3 is a block diagram of an exemplary personal communication system 300 that includes interface apparatus 100. In the exemplary embodiment, system 300 includes personal communication device 302, which may be, for example and not by way of limitation, a cellular phone. Personal communication device 302 includes a wireless transceiver 304 that communicates with both first portion wireless transceiver 106 and second portion wireless transceiver 112 using a wireless communication protocol such as Bluetooth®. As such, wireless transceiver 304 is capable of forming multiple simultaneous wireless connections.

During operation, personal communication device 302 transmits communication data, via device wireless transceiver 304, using a communication protocol and a first wireless connection to first portion wireless transceiver 106. The communication data is processed as described above, wherein the communication data is used to generate an incoming audio signal that is output to the user via speaker 110. Microphone 116 detects an outgoing audio signal, such as audible speech, from the user. The outgoing audio signal is used to generate outgoing communication data, which is then transmitted to device wireless transceiver 304 by second portion wireless transceiver 112 using a second wireless connection.

In an alternative embodiment, personal communication device 302 transmits communication data, via device wireless transceiver 304, using a communication protocol and a first wireless connection, to second portion wireless transceiver 112. Second portion wireless transceiver 112 then transmits the communication data to first portion wireless transceiver 106 via a second wireless connection. The communication data is processed and output to the user as described above. Microphone 116 detects an outgoing audio signal from the user, and the outgoing audio signal is used to generate outgoing communication data, which is then transmitted by second portion wireless transceiver 112 to device wireless transceiver 304 using the first wireless connection. As such, in this embodiment, interface apparatus 100 and personal communication device 302 need only form a single wireless connection.

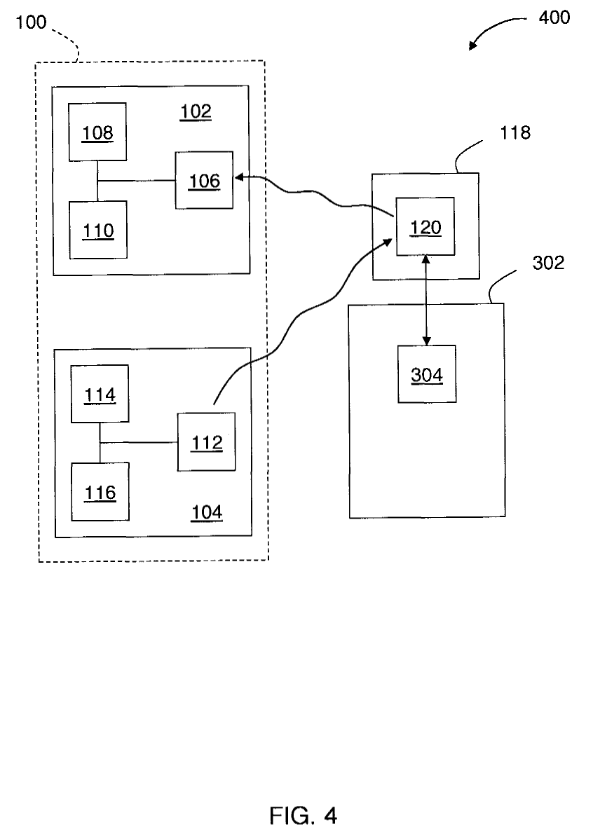

FIG. 4 is a block diagram of a second exemplary personal communication system 400 that includes interface apparatus 200. More specifically, in this embodiment, apparatus 200 includes third portion 118. As described above, third portion 118 is communicatively coupled to personal communication device 302 and, more specifically, to a wireless transceiver 304 within personal communication device 202. Alternatively, third portion 118 may be communicatively coupled to a processor (not shown) within personal communication device 302. Moreover, third portion 118 may be coupled, such as removeably coupled, to personal communication device 302. Further, third portion 118 includes a wireless transceiver 120 that receives communication data from device 302 via a first wireless connection or a wired connection and transmits the communication data to first portion 102 using a second wireless connection. Third portion wireless transceiver 120 also receives communication data from second portion 104 via a third wireless connection and transmits the communication data to personal communication device 202 via the first wireless connection or the wired connection. Third portion 118 may be used when, for example, personal communication device 302 is unable to form more than one wireless connection that uses the chosen wireless communication protocol. Moreover, third portion wireless transceiver 120 may be communicatively coupled to personal communication device 302 using a wired connection or using a wireless communication protocol.

In another alternative embodiment, third portion wireless transceiver 120 is configured to communicate wirelessly with first portion wireless transceiver 106 via one wireless connection, and personal communication device 302 is configured to communicate wirelessly with second portion wireless transceiver 112 via a different wireless connection. In yet another alternative embodiment, third portion wireless transceiver 120 is configured to communicate wirelessly with second portion wireless transceiver 112 using one wireless connection, and personal communication device 302 is configured to communicate wirelessly with first portion wireless transceiver 106 over a different wireless connection.

During operation, personal communication device 302 transmits communication data using a communication protocol to third portion wireless transceiver 120 using a first wireless connection or a wired connection. Wireless transceiver 120 receives the communication data and transmits the communication data to first portion wireless transceiver 106 using a second wireless connection. Wireless transceiver 106 receives the communication data and transmits the communication data to first portion processor 108. Based on the communication data, processor 108 generates an audio signal and transmits the audio signal to speaker 110. The audio signal is then output by speaker 110 to the user.

When the user responds to the audio signal output by speaker 110, a user-generated audio signal is detected by microphone 116. Microphone 116 transmits the audio signal to second portion processor 114. Based on the audio signal, processor 114 generates user-generated communication data and transmits the communication data to second portion wireless transceiver 112. Wireless transceiver 112 then transmits the communication data to third portion wireless transceiver 120 using a third wireless connection. Wireless transceiver 120 transmits the communication data to personal communication device 302 using the first wireless connection or the wired connection.

FIG. 4 is a flowchart 400 that illustrates an exemplary method of interfacing with personal communication device 302 (shown in FIGS. 3 and 4) using an interface apparatus, such as apparatus 100 (shown in FIG. 1) or apparatus 200 (shown in FIG. 2). In the exemplary embodiment, apparatus 100 receives 502 incoming communication data from personal communication device 302. More specifically, first portion wireless transceiver 106 receives incoming communication data from personal communication device wireless transceiver 304 via a first wireless connection (both shown in FIG. 3). Apparatus 100 processes 504 the incoming communication data in order to form an incoming audio signal, and outputs 506 the incoming audio signal to a user. More specifically, first portion wireless transceiver 106 transmits the incoming communication data to first portion processor 108 (shown in FIG. 3). First portion processor 108 generates the incoming audio signal based on the incoming communication data and transmits the incoming audio signal to speaker 110 (shown in FIG. 3). Speaker 110 then outputs the incoming audio signal to the user in the form of audible output.

Moreover, in the exemplary embodiment, when the user speaks, apparatus 100 detects 508 an outgoing audio signal, such as the user's voice. More specifically, microphone 116 detects the outgoing audio signal and transmits the outgoing audio signal to second portion processor 114 (both shown in FIG. 3). Apparatus 100 then processes 510 the outgoing audio signal in order to form outgoing communication data. More specifically, second portion processor 114 processes the outgoing audio signal in order to form the outgoing communication data, and transmits the outgoing communication data to second portion wireless transceiver 112 (shown in FIG. 3). Apparatus 100 then transmits 512 the outgoing communication data to personal communication device 302 using a second wireless connection. More specifically, second portion wireless transceiver 112 transmits the outgoing communication data to personal communication device wireless transceiver 304 using the second wireless connection.

In an alternative embodiment, personal communication device wireless transceiver 304 transmits incoming communication data to third portion 118 (shown in FIG. 4) of apparatus 200 via a first wireless communication protocol or a wired connection. Third portion wireless transceiver 120 (shown in FIG. 4) then transmits the incoming communication data to first portion wireless transceiver 106 using a second wireless connection. The incoming communication data is transmitted by first portion wireless transceiver 106 to first portion processor 108, which processes the incoming communication data to form an incoming audio signal. First portion processor 108 transmits the incoming audio signal to speaker 110, which audibly outputs the incoming audio signal to the user.

Moreover, in the alternative embodiment, microphone 116 detects an outgoing audio signal. Microphone 116 transmits the outgoing audio signal to second portion processor 114, which forms outgoing communication data based on the outgoing audio signal. Second portion processor 114 transmits the outgoing communication data to second portion wireless transceiver 112, which transmits the outgoing communication data to third portion wireless transceiver 120 using a third wireless connection. Third portion wireless transceiver 120 then transmits the outgoing communication data to personal communication device wireless transceiver 304 using the first wireless connection or wired connection.

The systems, methods, and apparatus described herein facilitate interfacing with a personal communication device, such as a cellular phone, using an interface apparatus that may be worn by the user in an inconspicuous manner. Such an interface apparatus may also be comfortably worn for longer periods of time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for interfacing with a personal communication device having at least one device transceiver, said apparatus comprising:
a first portion comprising a first wireless transceiver configured to communicate with the at least one device transceiver using a first wireless connection to facilitate transmitting incoming communication data from the communication device to a user through said first portion; and
a second portion comprising a second wireless transceiver configured to communicate with the at least one device transceiver using a second wireless connection maintained simultaneously to the first wireless connection to facilitate transmitting outgoing communication data from the user to the communication device through said second portion.

2. An apparatus in accordance with claim 1, wherein said first portion further comprises a speaker and a first processor coupled to said first wireless transceiver and said speaker.

3. An apparatus in accordance with claim 2, wherein said first processor is configured to:
receive the incoming communication data from said first wireless transceiver;
process the incoming communication data to form an incoming audio signal; and
transmit the incoming audio signal to said speaker.

4. An apparatus in accordance with claim 3, wherein said speaker is configured to audibly output the incoming audio signal to the user.

5. An apparatus in accordance with claim 2, wherein said first portion is sized to be inserted into an ear canal of the user.

6. An apparatus in accordance with claim 1, wherein said second portion further comprises a microphone and a second processor coupled to said second wireless transceiver and said microphone.

7. An apparatus in accordance with claim 6, wherein said microphone is configured to:
detect an audio input from the user;
to generate an outgoing audio signal; and
transmit the outgoing audio signal to said second processor.

8. An apparatus in accordance with claim 7, wherein said second processor is configured to:
receive the outgoing audio signal from said microphone;
process the outgoing audio signal to form the outgoing communication data; and
transmit the outgoing communication data to said second wireless transceiver.

9. An apparatus in accordance with claim 1, wherein said second portion is configured to be applied to the user's throat using one of a strap and an adhesive.

10. An apparatus in accordance with claim 1, wherein said second portion is configured to be applied to a clothing surface of the user.

11. An apparatus in accordance with claim 6, wherein said second portion is configured to be applied to a jaw bone of the user, said microphone comprises a vibration microphone configured to detect the outgoing audio signal based on vibrations of the user's jaw bone caused by speaking.

12. An apparatus in accordance with claim 3, wherein said first processor is configured to filter noise from at least one of the incoming communication data and the incoming audio signal.

13. An apparatus in accordance with claim 8, wherein said second processor is configured to filter noise from at least one of the outgoing audio signal and the outgoing communication data.

14. An apparatus in accordance with claim 1, further comprising a third portion comprising a third wireless transceiver electronically coupled to the communication device, said third wireless transceiver configured to receive the incoming communication data from the communication device and transmit the incoming communication data to said first wireless transceiver using the first wireless connection.

15. An apparatus in accordance with claim 14, wherein said third wireless transceiver is further configured to receive the outgoing communication data from said second wireless transceiver using the second wireless connection and transmit the outgoing communication data to the communication device.

16. A method of interfacing with a personal communication device having at least one device transceiver using an interface device, said method comprising:
receiving, by a first wireless transceiver, incoming communication data from the at least one device transceiver via a first wireless connection, the first wireless transceiver being part of a first portion of the interface device;
processing the incoming communication data to form an incoming audio signal to be audibly output to a user by the first portion;
detecting an outgoing audio signal using a second portion of the interface device;
processing the outgoing audio signal to form outgoing communication data; and
transmitting, by a second wireless transceiver within the second portion, the outgoing communication data to the at least one device transceiver using a second wireless connection.

17. A method in accordance with claim 16, further comprising applying the second portion of the interface device to the user's throat using one of a strap and an adhesive such that the outgoing audio signal is detected using a microphone within the second portion.

18. A method in accordance with claim 16, further comprising applying the second portion of the interface device to a clothing surface of the user such that the outgoing audio signal is detected using a microphone within the second portion.

19. A method in accordance with claim 16, further comprising applying the second portion of the interface device to a jaw bone of the user such that the outgoing audio signal is detected using a vibration microphone within the second portion based on vibrations of the user's jaw bone caused by speaking.

20. A method in accordance with claim 16, further comprising filtering noise from at least one of the incoming communication data, the incoming audio signal, the outgoing audio signal, and the outgoing communication data.

21. A personal communication system comprising:
a communication device comprising a transceiver configured to communicate using multiple simultaneous wireless connections;
an interface apparatus comprising a first portion and a separate second portion, said interface apparatus configured to receive input communication data via a first wireless connection from said communication device using a first wireless transceiver within said first portion and to transmit output communication data to said communication device via a second wireless connection using a second wireless transceiver within said second portion.

22. A personal communication system in accordance with claim 21, wherein said first portion further comprises a speaker and a first processor coupled to said first wireless transceiver and said speaker.

23. A personal communication system in accordance with claim 22, wherein said first processor is configured to:
receive the input communication data from said first wireless transceiver;
process the input communication data to form an input audio signal; and
transmit the input audio signal to said speaker.

24. A personal communication system in accordance with claim 23, wherein said speaker is configured to audibly output the input audio signal.

25. A personal communication system in accordance with claim 21, wherein said first portion is sized to be inserted into an ear canal of a user.

26. A personal communication system in accordance with claim 21, wherein said second portion further comprises a microphone and a second processor coupled to said second wireless transceiver and said microphone.

27. A personal communication system in accordance with claim 26, wherein said microphone is configured to:
detect an audio input from a user;
generate an output audio signal; and
transmit the output audio signal to said second processor.

28. A personal communication system in accordance with claim 27, wherein said second processor is configured to:
receive the output audio signal from said microphone;
process the output audio signal to form the output communication data; and
transmit the output communication data to said second wireless transceiver.

29. A personal communication system in accordance with claim 21, wherein said second portion is configured to be applied to a user's throat using one of a strap and an adhesive.

30. A personal communication system in accordance with claim 21, wherein said second portion is configured to be applied to a clothing surface of a user.

31. A personal communication system in accordance with claim 26, wherein said second portion is configured to be applied to a jaw bone of a user, said microphone comprises a vibration microphone configured to detect the outgoing audio signal based on vibrations of the user's jaw bone caused by speaking.

32. A personal communication system in accordance with claim 23, wherein said first processor is configured to filter noise from at least one of the input communication data and the input audio signal.

33. A personal communication system in accordance with claim 28, wherein said second processor is configured to filter noise from at least one of the outgoing audio signal and the outgoing communication data.
